(19) United States
(12) Patent Application Publication
(10) Pub. No.: US 2025/0031295 A1
(43) Pub. Date: Jan. 23, 2025

(54) SYSTEMS, DEVICES, AND METHODS FOR STARTING PLASMA

(71) Applicant: 6K Inc., North Andover, MA (US)

(72) Inventors: Zongren Shang, Westborough, MA (US); Michael C. Kozlowski, Reading, MA (US)

(21) Appl. No.: 18/604,243

(22) Filed: Mar. 13, 2024

Related U.S. Application Data
(63) Continuation of application No. 17/448,135, filed on Sep. 20, 2021, now Pat. No. 11,963,287.
(60) Provisional application No. 63/082,919, filed on Sep. 24, 2020.

(51) Int. Cl. H05H 1/30; B23K 10/00; B33Y 40/10

(52) U.S. Cl. CPC H05H 1/30; B23K 10/006; B33Y 40/10

(57) ABSTRACT

Some embodiments herein are directed to devices and methods for automatically starting a plasma utilizing a wand. In some embodiments, the wand may be used to start a plasma in a plasma torch such as, for example, a microwave plasma torch or an induction plasma torch, as discussed below. The wand may comprise an elongate, hollow wand member comprising a closed distal end, a proximal end, and one or more apertures extending from a hollow interior of the wand member to an exterior surface of the wand member; and an elongate wire member positioned within the hollow interior of the wand member and extending along at least a portion of a length of the wand member, wherein the wire member is configured to be placed in operable communication through the aperture with a power source, such that the power source can be activated to in turn start the plasma within the plasma torch. The plasma torches discussed herein may be used in various applications including, for example, high volume synthesis of advanced materials such as nano-materials, micro-powders, coatings, alloy compositions for additive manufacturing.

### INCORPORATION BY REFERENCE TO ANY PRIORITY APPLICATIONS

This application is a continuation of U.S. patent application Ser. No. 17/448,135, filed Sep. 20, 2021, which claims the priority benefit under 35 U.S.C. § 119 (e) of U.S. Provisional Application No. 63/082,919, filed Sep. 24, 2020, the entire disclosure of which is incorporated herein by reference. Any and all applications for which a foreign or domestic priority claim is identified in the Application Data Sheet as filed with the present application are hereby incorporated by reference under 37 CFR 1.57.

### BACKGROUND

### Field of the Invention

The disclosure herein relates to devices and methods for starting a plasma and, in particular, to devices and methods for automatically starting a plasma.

### Description of the Related Art

Plasma torches generate and provide high temperature directed flows of plasma for a variety of purposes. The two main types of plasma torches are induction plasma torches and microwave plasma torches. Although there are several distinct differences between these two types of torches, they both provide high temperature plasmas.

These high temperature plasmas may, for example, enable processing of a variety of materials that are exposed to or fed into the plasma. One such type of processing is taking one or more materials of a particular size and shape and, after exposing or feeding it into the plasma, process or transform the one or more materials into a different size or shape.

Initially igniting or “starting” a plasma typically is done manually by exposing a particular material into the plasma torch which sparks to ignite the plasma. This procedure can be dangerous to an operator and typically contaminates the process with excess material from the material used to create the spark.

It therefor would be desirable to provide a method and device for overcoming the problems with existing processes.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are related to a device for starting a plasma of a plasma torch, the device comprising: an elongate, hollow wand member comprising a closed distal end, a proximal end, and one or more apertures extending from a hollow interior of the wand member to an exterior surface of the wand member; and an elongate wire member comprising one or more wires positioned within the hollow interior of the wand member and extending along at least a portion of a length of the wand member, wherein the wire member is configured to be placed in operable communication through the aperture with a power source, such that the power source can be activated to in turn start the plasma within the plasma torch, wherein the wire member is configured to remain substantially within the hollow interior of the wand member when the plasma is started.

In some embodiments, the power source comprises a microwave generator, and wherein a length of the wire member comprises ¼ of a wavelength or longer of a microwave generated by the microwave generator.

In some embodiments, the wand member comprises one aperture. In some embodiments, the wand member comprises between 1 and 100 apertures. In some embodiments, the wire member comprises one wire. In some embodiments, the wire member comprises more than one wire. In some embodiments, wand member comprises quartz. In some embodiments, the wand member comprises a microwave-transparent material. In some embodiments, the wire member comprises a metal. In some embodiments, the wire member comprises a metal alloy. In some embodiments, the wand member comprises an open proximal end.

In some embodiments, at least one of the one or more apertures is located proximate the closed distal end of the wand member. In some embodiments, the wire member extends at least from a position proximate the closed distal end to a position outside of the proximal end. In some embodiments, the wand member comprises a plurality of apertures proximate the closed distal end of the hollow wand member. In some embodiments, the wire member is fused to the hollow interior of the wand member. In some embodiments, the wand member is in operable communication with a motor. In some embodiments, the motor is configured to impart motion on the wand member to place the wand member within the plasma torch, such that the wire member is configured to be placed in operable communication through the aperture with the power source and the heated gas flow. In some embodiments, the motor is configured to move the device into a gas flow of the plasma torch. In some embodiments, moving the device into the gas flow places the wire member in operable communication through the aperture with the power source. In some embodiments, the motor is configured to move the device out of the gas flow of the plasma torch. In some embodiments, the motor is in operable communication with a control unit, the control unit programmed to provide one or more control signals to the motor. In some embodiments, the control unit is configured to transmit an instruction to the power source to start the plasma of the plasma torch. In some embodiments, the wand member is in operable communication with a limit switch comprising an actuator for determining a location of the wand member.

Some embodiments herein are related to a system for starting a plasma of a plasma torch, the system comprising: an elongate, hollow wand member comprising a closed distal end, a proximal end, and one or more apertures extending from a hollow interior of the wand member to an exterior surface of the wand member; an elongate wire member positioned within the hollow interior of the wand member and extending along at least a portion of a length of the wand member, wherein the wire member can be placed in operable communication through the aperture with a power source and a heated gas flow, such that the power source can be activated to start the plasma within the plasma torch; a motor in operable communication with the wand member, the motor configured to impart motion on the wand member to place the wand member within the plasma torch, such that the wire member is configured to be placed in operable communication through the aperture with the power source and the heated gas flow; and a control unit in communication with the motor and programmed to provide one or more control signals to the motor.

In some embodiments, the power source comprises a microwave generator, and wherein a length of the wire member comprises ¼ of a wavelength or longer of a microwave generated by the microwave generator. In some embodiments, the wand member comprises one aperture. In some embodiments, the wand member comprises between 1 and 100 apertures. In some embodiments, the wire member comprises one wire. In some embodiments, the wire member comprises more than one wire. In some embodiments, the wand member comprises quartz. In some embodiments, the wand member comprises a microwave-transparent material. In some embodiments, the wire member comprises a metal. In some embodiments, the wire member comprises a metal alloy. In some embodiments, the wand member comprises an open proximal end. In some embodiments, at least one of the one or more apertures is located proximate the closed distal end of the wand member. In some embodiments, the wire member extends at least from a position proximate the closed distal end to a position outside of the proximal end. In some embodiments, the wand member comprises a plurality of apertures proximate the closed distal end of the hollow wand member. In some embodiments, the wire member is fused to the hollow interior of the wand member.

In some embodiments, the system further comprises a limit switch comprising an actuator for determining a location of the wand member. In some embodiments, the system further comprises the plasma torch.

Some embodiments herein relate to a method of automatically starting a plasma of a plasma torch, the method comprising: transmitting, via a control unit, an instruction to start the plasma of the plasma torch; moving, using a motor in communication with the control unit, a device for starting the plasma into a gas flow of the plasma torch, the device comprising: an elongate, hollow wand member, the wand member comprising a closed distal end, a proximal end, and one or more apertures extending from a hollow interior of the wand member to an exterior surface of the wand member; and an elongate wire member positioned within the hollow interior of the wand member and extending along at least a portion of a length of the wand member, wherein moving the device into the gas flow places the wire member in operable communication through the aperture with a power source; and activating the power source to start the plasma within the plasma torch.

In some embodiments, the method further comprises moving, using the motor, the device out of the gas flow of the plasma torch. In some embodiments, the power source comprises a microwave generator, and wherein a length of the wire member comprises ¼ of a wavelength or longer of a microwave generated by the microwave generator. In some embodiments, the wand member comprises one aperture. In some embodiments, the wand member comprises between 1 and 100 apertures. In some embodiments, the wire member comprises one wire. In some embodiments, the wire member comprises more than one wire. In some embodiments, the wand member comprises quartz. In some embodiments, the wand member comprises a microwave-transparent material. In some embodiments, the wire member comprises a metal. In some embodiments, the wire member comprises a metal alloy. In some embodiments, the wand member comprises an open proximal end. In some embodiments, at least one of the one or more apertures is located proximate the closed distal end of the wand member. In some embodiments, the wire member extends at least from a position proximate the closed distal end to a position outside of the proximal end. In some embodiments, the wand member comprises a plurality of apertures proximate the closed distal end of the hollow wand member. In some embodiments, the wire member is fused to the hollow interior of the wand member.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an embodiment of a top feeding microwave plasma torch that can be used in the production of powders, according to embodiments of the present disclosure.

FIGS. 2A-2B illustrate embodiments of a microwave plasma torch that can be used in the production of powders, according to a side feeding hopper embodiment of the present disclosure.

FIG. 3 illustrates an embodiment of an autostrike wand mechanism for striking a microwave plasma torch, according to embodiments of the present disclosure.

FIG. 4 illustrates a cross-sectional view of an embodiment of an autostrike wand mechanism for striking a microwave plasma torch, according to embodiments of the present disclosure.

FIG. 5 illustrates an embodiment of a motor and friction roller mechanism for controlling the motion of an autostrike wand, according to embodiments of the present disclosure.

FIG. 6 illustrates an embodiment of an upper limit switch mechanism for use in a microwave plasma torch with an autostrike wand, according to embodiments of the present disclosure.

FIG. 7 illustrates an embodiment of an autostrike wand for striking a plasma torch, according to embodiments of the present disclosure.

FIG. 8 illustrates another embodiment of an autostrike wand for striking a plasma torch, according to embodiments of the present disclosure.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Igniting, “striking” or “starting” a plasma previously was done manually by exposing a particular material, usually metal, into the plasma torch which sparks to ignite the plasma. Sometimes, a microwave plasma torch with a microwave generator may be initialized at low power, followed by insertion, by a human operator, of a metal material through a port of the plasma torch, into the gas flow of the plasma torch. The metal material may initiate a spark, which ignites the plasma torch. Upon ignition, the human operator may manually withdraw the metal material through the port. This procedure can be dangerous to an operator and typically contaminates the process with excess material from the metal material used to create the spark. This contamination can affect the temperature and processing conditions within the plasma torch, as well as the quality of a final product produced using the plasma torch. Thus, novel methods and devices for overcoming the problems with existing plasma striking processes are desired.

Some embodiments herein are directed to devices and methods for automatically starting a plasma utilizing a wand. In some embodiments, the wand may be used to start a plasma in a plasma torch such as, for example, a microwave plasma torch or an induction plasma torch, as discussed below. The plasma torches discussed herein may be used in various applications including, for example, high volume synthesis of advanced materials such as nano-materials, micro-powders, coatings, alloy compositions for additive manufacturing. For example, the auto-strike wands discussed herein may be used in UniMelt® systems by 6K Inc., with an address of 32 Commerce Way, North Andover, Massachusetts, 01845. Such systems are capable of continuous-flow production of advanced materials with high volume, low porosity, and enhanced sphericity to comparable systems. Such systems function by combining highly reactive ions with designed chemistries under high heat to create a continuous-flow, high-throughput production environment. In some embodiments, such systems may operate at atmospheric pressure. Microwave-engineered plasma provides a thermal production zone of extreme uniformity, such that each particle is introduced to the same thermal kinetics.

In some embodiments, the wand may be used to automatically start a plasma such that an operator is not required to manually introduce a material into a torch flow in order to start the plasma. Instead, the wand may be introduced into a plasma torch using a remote process and/or a controller. After ignition of the plasma, a stable and continuous operation of the plasma is possible and the plasma torch can be used for various applications, including production of powders or other advanced materials. As such, the embodiments herein utilize a plasma physics theory to implement a plasma-starting mechanism, which provides a high efficiency, high success-rate, and long-lasting plasma starting structure.

In some embodiments, the wand may comprise quartz and/or other microwave-transparent materials, such as glasses or alumina. In some embodiments, the wand may also comprise an enclosed antenna comprising one or more metal wires. In some embodiments, this structure contains the wire, which minimizes the risk of having the antenna slip free. In some embodiments, the metal antenna may be fused to an interior surface of the wand to keep the antenna fixed in place. The length of the metal wire may also be varied. For example, in some embodiments, the metal wire may extend the entire length of the wand. Alternatively, in some embodiments, the metal wire may extend only partially along the length of the wand. For example, the metal wire may be provided only at the location of one or more apertures in the wand, as described in detail below. In some embodiments, the antenna length may correspond to a wavelength of an electromagnetic wave used in the microwave plasma torch. For example, the antenna length may comprise about ¼ the length of the wavelength of the microwave of the plasma torch, or a multiple of ¼ the length of the wavelength. In some embodiments, the antenna length may comprise about ⅛, about ¼, about ⅜, about ½, about ¾, about ⅞, about 1 wavelength or longer than the microwave of the plasma torch.

The wand may comprise one or more apertures, cuts, or slots (hereinafter “apertures”), which extend from an exterior surface of the wand to the one or more metal wires. In some embodiments, the single or multiple wire antenna is located on the interior of the wand in communication with the one or more apertures in the wand to achieve a high successful rate of starting plasma. Without being limited to any specific theory, the presence of the apertures in the wand allow electrons to migrate from the metal wire into a gas flow. This flow of electrons may initialize a cascade of ionization in the gas species, which “strikes” the plasma in the plasma torch. In some embodiments, the one or more apertures on the wand may minimize contamination of wire vaporization within the plasma torch. Furthermore, in some embodiments, if the feed stock of the plasma torch is a metal, the antenna material can be formed of the same metal as the feed stock, such that contamination is substantially eliminated. As such, applying the wand and antenna structure into an auto-striking plasma torch to automatically start plasma provides benefit in the manufacture of materials with plasma processes.

In some embodiments, the number, placement, and orientation of the apertures may be varied to optimize the efficiency of the striking mechanism and to minimize contamination of the metal wire into the plasma torch.

The wand may be capable of striking plasma in many different gas species including, for example, N₂, Ar, H₂, hydrocarbons, other nobles gases, and other gas mixtures (e.g. 90% Ar, 10% H₂). It will be understood that the above recited gases are exemplary in nature and that any gas may be used as a plasma gas species depending on the specific application.

In some embodiments, a motor may be used, in combination with friction rollers and an upper limit switch, to control the motion of the wand into and out of the gas flow within the plasma torch. The friction rollers, driven by the motor, move the wand, including the one or metal wires inside, up and down using friction force. The upper limit switch senses the wand location and ensures that the wand does not extend beyond its intended range of motion. The limit switch may be used as part of a control system, as a safety interlock, and/or to count the number of times the wand has been used to strike the plasma.

The devices and methods described herein have a high successful rate of starting a plasma in a plasma chamber or torch. An operator of a plasma torch can use the devices and methods to start a plasma at a distance to improve the safety of the operator. Furthermore, the wand described herein may increase the life of the striking wand and metal wires, such that the components need replacement less frequently. Furthermore, the wand design minimalizes contamination of the antenna material in the process chamber.

### Plasma Torches

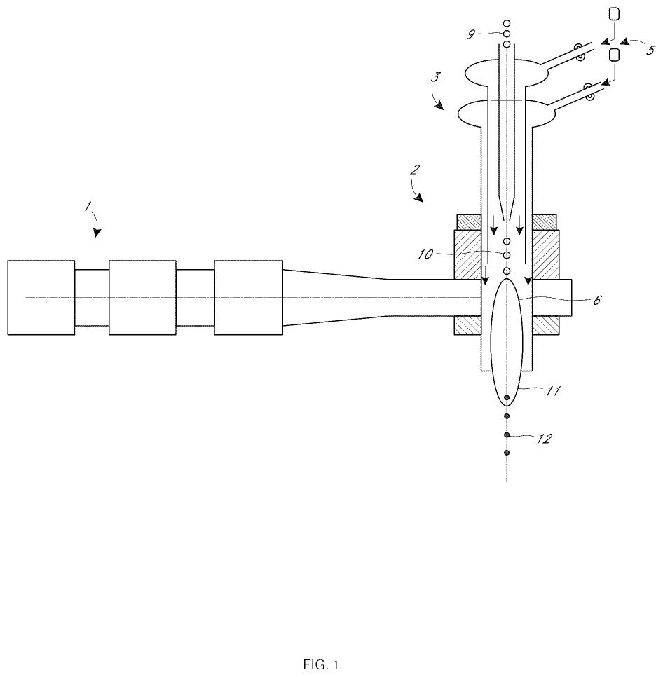

FIG. 1 illustrates an exemplary top feed microwave plasma torch that can be used in the production of powders, according to embodiments of the present disclosure. In some embodiments, feed materials 9, 10 can be introduced into a microwave plasma torch 3, which sustains a microwave generated plasma 11. In one example embodiment, an entrainment gas flow and a sheath flow (downward arrows) may be injected through inlets 5 to create flow conditions within the plasma torch prior to ignition of the plasma 11 via microwave radiation source 1. The feed materials 9 are introduced axially into the microwave plasma torch, where they are entrained by a gas flow that directs the materials toward the plasma. As discussed above, the gas flows can consist of a noble gas column of the periodic table, such as helium, neon, argon, etc.

Within the microwave generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch 3 to protect it from melting due to heat radiation from plasma 11. In exemplary embodiments, the laminar flows direct particles 9, 10 toward the plasma 11 and hot zone 6 along a path as close as possible to axis 12, exposing them to a substantially uniform temperature within the plasma. In some embodiments, suitable flow conditions are present to keep particles 10 from reaching the inner wall of the plasma torch 3 where plasma attachment could take place. Particles 9, 10 are guided by the gas flows towards microwave plasma 11 were each undergoes homogeneous thermal treatment.

Various parameters of the microwave generated plasma, as well as particle parameters, may be adjusted in order to achieve desired results. These parameters may include microwave power, feed material size, feed material insertion rate, gas flow rates, plasma temperature, residence time and cooling rates. As discussed above, in this particular embodiment, the gas flows are laminar; however, in alternative embodiments, swirl flows or turbulent flows may be used to direct the feed materials toward the plasma.

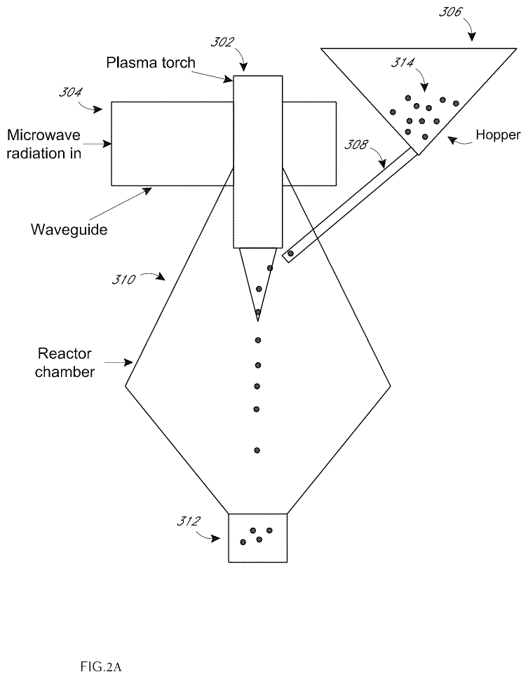

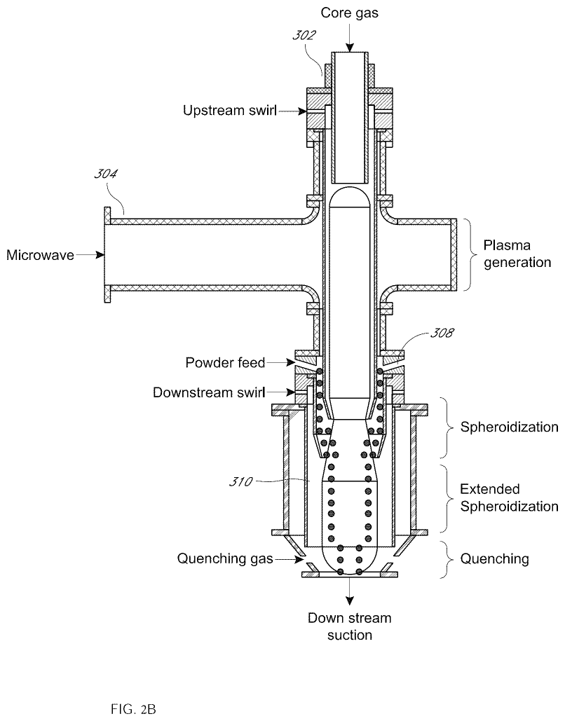

FIGS. 2A-B illustrate an exemplary microwave plasma torch that includes a side feeding hopper rather than the top feeding hopper shown in the embodiment of FIG. 1 thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 1. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, now U.S. Pat. No. 10,987,735, or swirl torches described in U.S. Pat. No. 8,748,785 B2 and U.S. Pat. No. 9,932,673 B2. Both FIG. 2A and FIG. 2B show embodiments of a method that can be implemented with either an annular torch or a swirl torch. A feed system close-coupled with the plasma plume at the exit of the plasma torch is used to feed powder axisymmetrically to preserve process homogeneity. Other feeding configurations may include one or several individual feeding nozzles surrounding the plasma plume.

The feed materials 314 can be introduced into a microwave plasma torch 302. A hopper 306 can be used to store the feed material 314 before feeding the feed material 314 into the microwave plasma torch 302, plume, or exhaust. In alternative embodiments, the feedstock can be injected along the longitudinal axis of the plasma torch. The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase and cool and solidify outside the plasma chamber. In some embodiments, a quenching chamber may be used, which may or may not use positive pressure. While described separately from FIG. 1, the embodiments of FIGS. 2A-2B are understood to use similar features and conditions to the embodiment of FIG. 1.

### Autostrike Devices and Methods

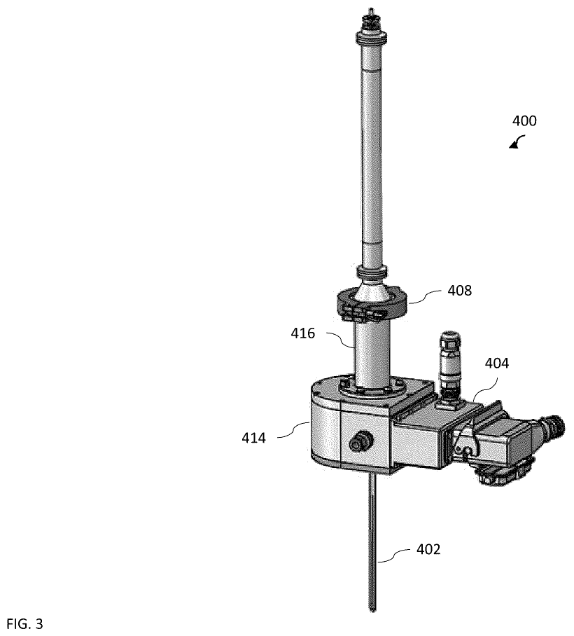

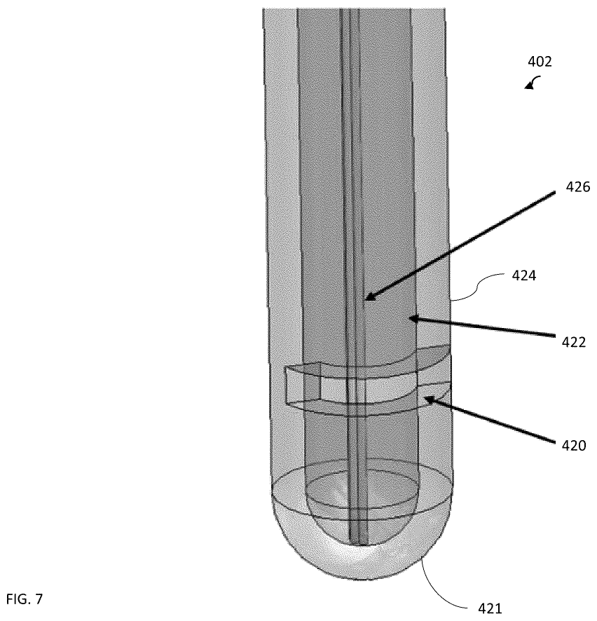

FIG. 3 illustrates an embodiment of an autostrike wand mechanism for striking a microwave plasma torch, according to embodiments of the present disclosure. The autostrike wand mechanism 400 may be utilized to strike a plasma torch without manual operation by an operator. The plasma torch may be any induction or electromagnetic wave plasma torch, including the microwave plasma torch 3 of FIG. 1 and the microwave plasma torch 302 of FIGS. 2A-2B. The autostrike wand mechanism 400 may be remotely controlled via an operator or via a computerized controller. The function of the autostrike wand mechanism may be insertion of an autostrike wand 402 into a plasma torch gas flow to start the plasma torch. The wand 402 may comprise an outer shell of quartz, glass, and/or other microwave-transparent materials, as described in detail below in reference to FIG. 7. The wand 402 may also comprise a hollow core in which a metal wire antenna may be located. One or more open apertures may be cut into the wand 402 to allow the metal wire antenna to directly contact a plasma torch gas flow under high heat in order to strike the plasma torch. The wand 402 may be inserted into the plasma torch gas flow in an orientation parallel to, perpendicular to, or at another angle with respect to the gas flow. After striking the plasma torch, the wand 402 may be retracted from the plasma torch gas flow to minimize contamination of the metal wire into the plasma torch and products, and to preserve the wand 402 for repeated use.

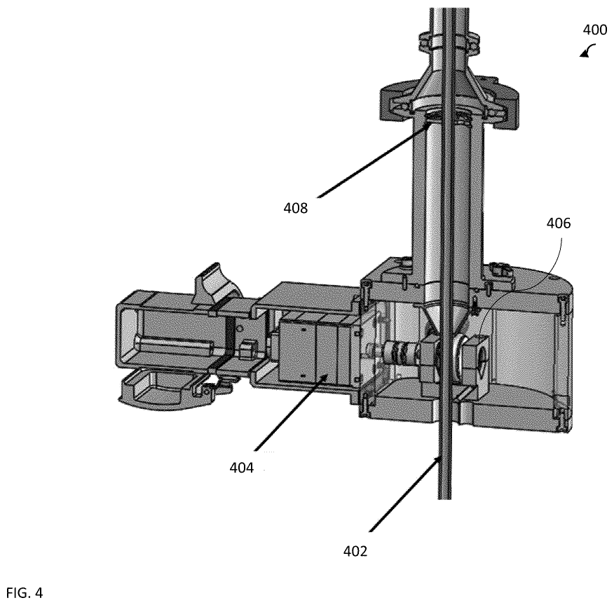

The wand 402 may be inserted into and retracted from the plasma torch gas flow using a motor 404 to drive one or more friction rollers 406, as shown in FIG. 4. In some embodiments, the motor 404 and therefore friction rollers 406 may be controlled remotely via an operator or a computerized, automated controller. Thus, the autostrike wand mechanism 400 may be used to start plasma torch with no human operator present in proximity to the plasma torch for enhanced safety. The autostrike wand 402 may also be supported within the autostrike wand mechanism 400 by one or more wand bearings 408, which maintain the orientation and integrity of the autostrike wand 402. A limit switch 410 may be used to sense the wand 402 at a home position.

FIG. 4 illustrates a cross-sectional view of an embodiment of an autostrike wand mechanism for striking a microwave plasma torch, according to embodiments of the present disclosure. The illustrated cross-section of FIG. 4 shows friction rollers 406, driven by motor 404. In the illustrated embodiment, the friction rollers 406 may be driven by motor 404 to move or translate wand 402 vertically up and down. Wand bearing 408 may secure the orientation of wand 402 within the autostrike wand mechanism 400.

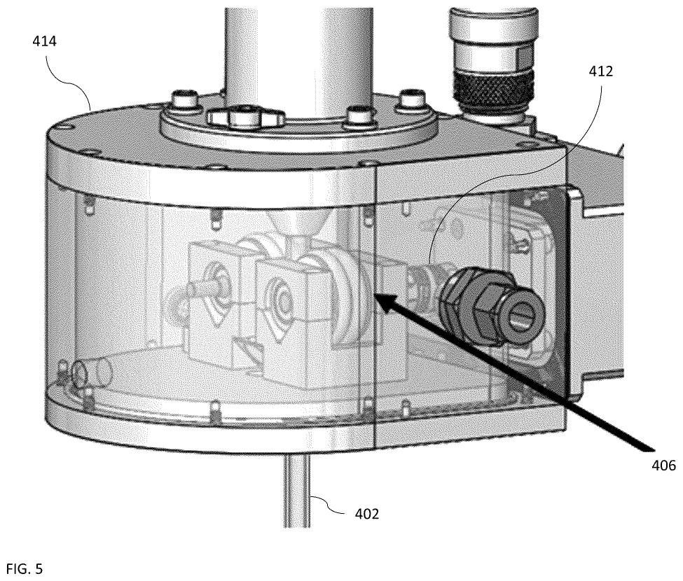

FIG. 5 illustrates an embodiment of a motor and friction roller mechanism for controlling the motion of an autostrike wand, according to embodiments of the present disclosure. In the illustrated embodiment, motor 404 is connected to friction rollers 406 via a driveshaft 412, which transmits torque and rotation from motor 404 to friction rollers 406. In such a way, friction rollers 406 may convey wand 402 into and out of a plasma torch in order to ignite the torch. In some embodiments, friction rollers 406 may be housed within a wand mechanism body 414, which may be connected to a wand housing 416, where the wand bearing 408 is located. In some embodiments, the wand housing 416 and/or the wand mechanism body 414 may be vacuum sealed from the motor and other components.

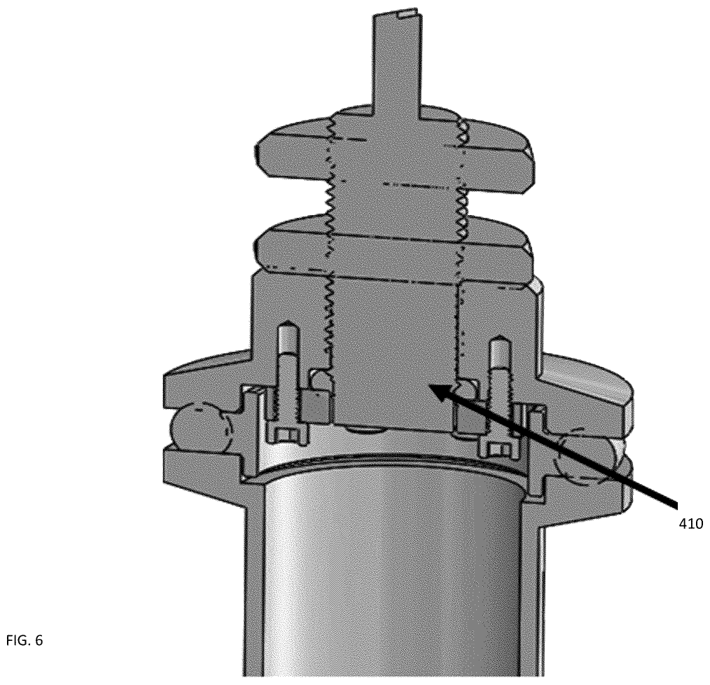

FIG. 6 illustrates an embodiment of an upper limit switch mechanism for use in a microwave plasma torch with an autostrike wand, according to embodiments of the present disclosure. In some embodiments, limit switch 410 may be used as part of a wand control system, as a safety interlock, or to sense a home position of the wand 402, outside of a plasma torch gas flow. A limit switch is an electromechanical device that consists of an actuator mechanically linked to a set of contacts. When the wand 402 contacts the actuator, the limit switch 410 operates the contacts to make or break an electrical connection, which can be transmitted to a controller.

FIG. 7 illustrates an embodiment of an autostrike wand for striking a plasma torch, according to embodiments of the present disclosure. The wand 402 may comprise an elongate, hollow wand member made substantially of quartz or another microwave transparent material, having a closed distal end 421 and an open proximal end and one or more apertures 420 extending from a hollow interior 422 of the wand member to an exterior 424 of the wand member, the one or more apertures having a predetermined shape and size that can vary as required, the hollow wand member being designed for operable communication with a plasma torch.

The wand 402 may also comprise an elongate wire member or antenna 426 positioned within the interior 422 of the hollow wand member 402 and extending at least from a position proximate the closed distal end 421 and the one or more openings 420 to a position outside of the open proximal end, wherein the wire member or antenna 426 is designed for operable communication through the one or more apertures 420 with a particular power source, such as a microwave generator, such that the power source can be activated to in turn start the plasma within a microwave plasma torch.

In some embodiments, the wand 402 may comprise quartz and/or other microwave-transparent materials, such as glasses. In some embodiments, the antenna 426 may comprise one or more metal wires. The wand 402 may enclose the one or more wires except at the one or more apertures, which minimizes the risk of having the one or more wires slip free and contaminate the plasma torch. In some embodiments, the antenna may comprise a metal or a metal alloy. In some embodiments, the antenna 426 may be fused to the interior 422 of the wand 402 to keep the antenna fixed in place. For example, the antenna 425 may be fused by a glass-to-metal oxide bond to the interior 422. The length of the antenna 426 may also be varied. For example, in some embodiments, the metal wire may extend the entire length of the wand 402. Alternatively, in some embodiments, the antenna 426 may extend only partially along the length of the wand 402. For example, the metal wire may be provided only at the location of one or more apertures 420 in the wand. In some embodiments, the antenna length may correspond to a wavelength of an electromagnetic wave used in the microwave plasma torch. For example, the antenna length may comprise about ¼ the length of the wavelength of the microwave of the plasma torch, or a multiple of ¼ the length of the wavelength. In some embodiments, the antenna length may comprise about ⅛, about ¼, about ⅜, about ½, about ¾, about ⅞, about 1 wavelength or longer than the microwave of the plasma torch. Without being limited by theory, an antenna length of about ¼ the length of the wavelength or more generates a maximum voltage across the antenna. Higher voltage will increase the amount of electrons emitted by wire into the gas flow of the plasma torch, such that ionization of gas is maximized to start a chain reaction, such that the plasma is ignited. In some embodiments, a shorter antenna length may be used depending on the properties of the specific metals used in the antenna.

In some embodiments, the number of apertures 420 may not be limited. In some embodiments, the number, placement, and orientation of the apertures 420 may be varied to optimize the efficiency of the striking mechanism and to minimize contamination of the antenna 426 into the plasma torch.

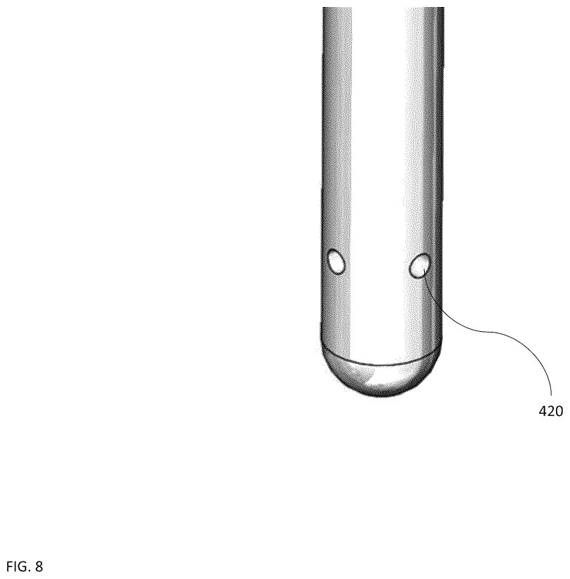

FIG. 8 illustrates another embodiment of an autostrike wand for striking a plasma torch, according to embodiments of the present disclosure. As noted above, the size orientation and number of apertures 420 may be varied according to the desired process condition. The apertures 420 may be circular in shape, as illustrated in FIG. 8.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

1. A device for starting a plasma of a plasma torch, the device comprising:
an elongate, hollow wand member comprising a closed distal end, a proximal end, and one or more apertures extending from a hollow interior of the wand member to an exterior surface of the wand member; and
an elongate wire member comprising one or more wires positioned within the hollow interior of the wand member and extending along at least a portion of a length of the wand member, wherein the wire member is configured to be placed in operable communication through the one or more apertures with a power source, such that the power source can be activated to in turn start the plasma within the plasma torch,
wherein the wire member is configured to remain substantially within the hollow interior of the wand member when the plasma is started.

2. The device of claim 1, wherein the one or more apertures are proximate to the closed distal end.

3. The device of claim 1, wherein the one or more apertures extend to an exterior surface on a lateral side of the wand member.

4. The device of claim 1, wherein the power source comprises a microwave generator, and wherein a length of the wire member comprises ¼ of a wavelength or longer of a microwave generated by the microwave generator.

5. The device of claim 1, wherein the wand member comprises between 1 and 100 apertures.

6. The device of claim 1, wherein the wire member comprises one wire.

7. The device of claim 1, wherein the wire member comprises more than one wire.

8. The device of claim 1, wherein the wand member comprises quartz or another microwave-transparent material.

9. The device of claim 1, wherein the wire member comprises a metal or metal alloy.

10. The device of claim 1, wherein the wand member comprises an open proximal end.

11. The device of claim 1, wherein the wire member extends at least from a position proximate the closed distal end to a position outside of the proximal end.

12. The device of claim 1, wherein the wire member is fused to the hollow interior of the wand member.

13. The device of claim 1, wherein the wand member is in operable communication with a motor.

14. A method of automatically starting a plasma of a plasma torch, the method comprising:
transmitting, via a control unit, an instruction to start the plasma of the plasma torch;
moving, using a motor in communication with the control unit, a device for starting the plasma into a gas flow of the plasma torch, the device comprising:
an elongate, hollow wand member, the wand member comprising a closed distal end, a proximal end, and one or more apertures extending from a hollow interior of the wand member to an exterior surface of the wand member; and
an elongate wire member positioned within the hollow interior of the wand member and extending along at least a portion of a length of the wand member,
wherein moving the device into the gas flow places the wire member in operable communication through the aperture with a power source; and
activating the power source to start the plasma within the plasma torch.

15. The method of claim 14, further comprising moving, using the motor, the device out of the gas flow of the plasma torch.

16. The method of claim 14, wherein the power source comprises a microwave generator.
